(19) United States
(12) Patent Application Publication
(10) Pub. No.: US 2019/0017590 A1
(43) Pub. Date: Jan. 17, 2019

(54) HYDRAULIC CONTROL DEVICE FOR VEHICLE TRANSMISSION APPARATUS

(71) Applicant: AISIN AW CO., LTD., Anjo-shi, Aichi-ken (JP)

(72) Inventor: Eikichi KIDOKORO, Anjo (JP)

(73) Assignee: AISIN AW CO., LTD., Anjo-shi, Aichi-ken (JP)

(21) Appl. No.: 16/066,432

(22) PCT Filed: Feb. 27, 2017
(86) PCT No.: PCT/JP2017/007581

§ 371 Date: Jun. 27, 2018

(30) Foreign Application Priority Data
Feb. 25, 2016 (JP) 2016-034100

(51) Int. Cl. F16H 61/00; F16K 27/04

(52) U.S. Cl. CPC F16H 61/0021; F16K 27/04; F15B 2211/329; F16H 61/0006; F16H 61/0009

(57) ABSTRACT

A hydraulic control device that includes a first layer including a first surface, a first groove having a semicircular cross-sectional shape and formed in the first surface, and a first oil passage having a circular cross-sectional shape, communicating with an end of the first groove, extending in a direction orthogonal to the first surface, and open to the first groove; a second layer including a second surface, and a second groove having a semicircular cross-sectional shape and formed in the second surface to face the first groove, the second layer being stacked on the first layer, with the second surface joined to the first surface; and a second oil passage having a circular cross-sectional shape, defined by the first groove in the first surface and the second groove in the second surface, and communicating with the first oil passage.

### BACKGROUND

The present disclosure relates to a hydraulic control device for a vehicle transmission apparatus mounted on a vehicle, for example.

There is a widely used hydraulic control device for a vehicle transmission apparatus. The hydraulic control device includes a valve body having various valves (hereinafter referred to simply as “valves”) such as a plurality of linear solenoid valves and switching valves, and oil passages that establish communication between the valves. Many valve bodies are formed of metal by aluminum die-casting or the like. However, in recent years, there has been developed a valve body that is formed by stacking synthetic resin blocks each having half-divided oil passages formed by injection molding, and integrating the blocks by welding (see Japanese Patent Application Publication No. 2012-82917). In such a valve body, each half-divided oil passage is a groove having a semicircular cross-sectional shape. The associated grooves are disposed to face each other at the interface between the stacked blocks, so that an oil passage having a circular cross-sectional shape is formed.

### SUMMARY

The valve body described above includes three or more stacked layers of blocks, and half-divided oil passages are joined at the interface between each two blocks. However, no consideration is given to the configuration for establishing communication between oil passages formed at different interfaces between layers in the stacking direction. Therefore, in the case of establishing communication between oil passages formed at different interfaces between layers, that is, for example, in the case of establishing communication between an oil passage formed between the lowermost block (resin molded article 11) and the second block from the bottom (resin molded article 12) and an oil passage formed between the second block from the bottom (resin molded article 12) and the third block from the bottom (resin molded article 13) in the stacking direction, the hydraulic pressure loss of circulating hydraulic oil is increased depending on the flow path shape of the communication portion of the oil passages.

An exemplary aspect of the disclosure provides a hydraulic control device for a vehicle transmission apparatus, capable of reducing pressure loss of hydraulic oil at a portion where oil passages formed at different interfaces between stacked layers communicate with each other in a stacking direction.

A hydraulic control device for a vehicle transmission apparatus according to the present disclosure includes: a first layer including a first surface, a first groove having a semicircular cross-sectional shape and formed in the first surface, and a first oil passage having a circular cross-sectional shape, communicating with an end of the first groove, extending in a direction orthogonal to the first surface, and open to the first groove; a second layer including a second surface, and a second groove having a semicircular cross-sectional shape and formed in the second surface to face the first groove, the second layer being stacked on the first layer, with the second surface joined to the first surface; and a second oil passage having a circular cross-sectional shape, defined by the first groove in the first surface and the second groove in the second surface, and communicating with the first oil passage; wherein the second groove at an end of the second oil passage communicating with the first oil passage is formed to have a depth gradually decreasing toward the end of the second oil passage, and is continuously connected to the first oil passage in the first layer.

According to the hydraulic control device for a vehicle transmission apparatus, the second groove at the end of the second oil passage is formed to have a depth gradually decreasing toward the end of the second oil passage, and is continuously connected to the first oil passage in the first layer. Accordingly, compared to the case where the bottom face and the end face of the second groove are arranged, for example, substantially at right angle, it is possible to prevent the cross-sectional area of the oil passage from varying greatly along the flow path. Therefore, pressure loss of hydraulic oil can be reduced at the portion where oil passages formed at different interfaces between stacked layers communicate with each other in the stacking direction.

### BRIEF DESCRIPTION OF THE DRAWINGS

FIG. 1 is a schematic diagram illustrating a vehicle on which a hydraulic control device for a vehicle transmission apparatus is mounted according to a first embodiment.

FIG. 2 is a perspective view illustrating the hydraulic control device according to the first embodiment.

FIG. 3 is an exploded perspective view illustrating the hydraulic control device according to the first embodiment.

FIG. 4 is a cross-sectional view illustrating the hydraulic control device according to the first embodiment.

FIG. 5A is a cross-sectional view illustrating oil passages in the hydraulic control device according to the first embodiment.

FIG. 5B is a plan view illustrating a fifth block of the hydraulic control device according to the first embodiment.

FIG. 5C is a cross-sectional view illustrating the fifth block of the hydraulic control device according to the first embodiment.

FIG. 6A is a cross-sectional view illustrating oil passages in a hydraulic control device according to a second embodiment.

FIG. 6B is a plan view illustrating a fifth block of the hydraulic control device according to the second embodiment.

FIG. 6C is a cross-sectional view illustrating the fifth block of the hydraulic control device according to the second embodiment.

FIG. 7A is a cross-sectional view illustrating oil passages in another hydraulic control device.

FIG. 7B is a plan view illustrating a fifth block of that other hydraulic control device.

FIG. 7C is a cross-sectional view illustrating the fifth block of that other hydraulic control device.

FIG. 8A is a cross-sectional view illustrating oil passages in a hydraulic control device having an undercut portion.

FIG. 8B is a plan view illustrating a fifth block of the hydraulic control. device having the undercut portion.

FIG. 9A is a cross-sectional view illustrating the hydraulic control device having the undercut portion, taken along line A-A of FIG. 8B.

FIG. 9B is a cross-sectional view illustrating the hydraulic control device having the undercut portion, taken along line B-B of FIG. 8B.

### DETAILED DESCRIPTION OF EMBODIMENTS

### First Embodiment

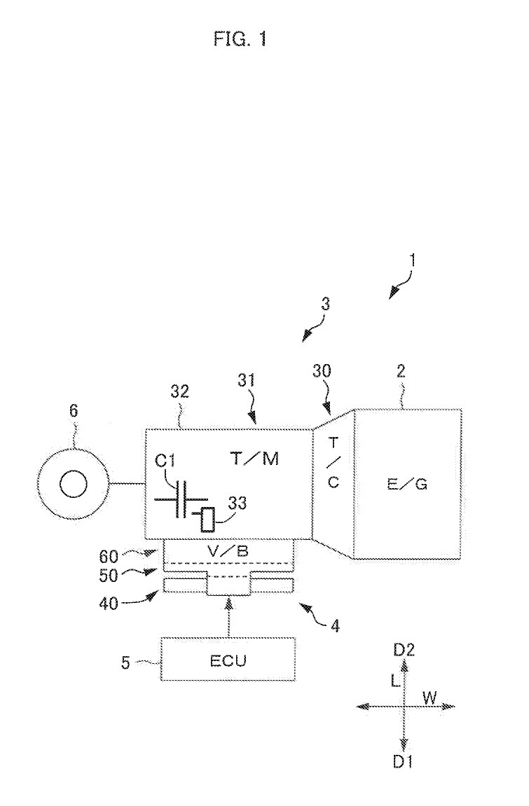

Hereinafter, a hydraulic control device for a vehicle transmission apparatus according to a first embodiment will be described with reference to FIGS. 1 to 5C. First, the schematic configuration of a vehicle 1 on which an automatic transmission 3 as an example of a vehicle transmission apparatus is mounted will be described with reference to FIG. 1. As illustrated in FIG. 1, the vehicle 1 according to the present embodiment includes, for example, an internal combustion engine 2, the automatic transmission 3, a hydraulic control device 4 and an ECU (control unit) 5 that control the automatic transmission 3, and wheels 6. The internal combustion engine 2 is, for example, a gasoline engine, a diesel engine, or the like, and is coupled to the automatic transmission 3. In the present embodiment, the automatic transmission 3 is of a so-called FR (front-engine, rear-wheel-drive) type. However, the automatic transmission 3 is not limited to the FR type, and may be of an FF (front-engine, front-wheel-drive) type. The hydraulic control device 4 may be usable for both the FR type automatic transmission 3 and an FF type automatic transmission. In the present embodiment, a vehicle using only an internal combustion engine as a drive source is described as an example of a vehicle to which a vehicle transmission apparatus is applied. However, the present disclosure is not limited thereto. The vehicle transmission apparatus may be applied to a hybrid vehicle using an internal combustion engine and an electric motor as drive sources, for example.

The automatic transmission 3 includes a torque converter 30, a speed change mechanism 31, and a transmission case 32 accommodating these components. The torque converter 30 is interposed between the internal combustion engine 2 and the speed change mechanism 31, and is capable of transmitting the drive force of the internal combustion engine 2 to the speed change mechanism 31 via hydraulic fluid.

The speed change mechanism 31 is a multi-stage speed change mechanism capable of establishing a plurality of shift speeds by engaging and disengaging a plurality of clutches including a first clutch (friction engagement element) C1 and a brake. The speed change mechanism 31 includes a hydraulic servo 33 capable of engaging and disengaging the first clutch C1 by supplying and exhausting hydraulic pressure. The speed change mechanism 31 is not limited to a multi-stage speed change mechanism, but may be a continuously variable speed change mechanism such as a belt-type continuously variable automatic speed change mechanism.

The hydraulic control device 4 is formed of a valve body, for example, The hydraulic control device 4 generates line pressure, modulator pressure, and the like, from hydraulic pressure supplied from an oil pump (not illustrated), and thus can supply and exhaust hydraulic pressure for controlling each clutch and brake of the speed change mechanism 31, based on a control signal from the ECU 5. The configuration of the hydraulic control device 4 will be described in detail below.

The ECU 5 includes, for example, a CPU, a ROM that stores a processing program, a RAM that temporality stores data, input and output ports, and a communication port. The ECU 5 outputs various signals such as a control signal for the hydraulic control device 4, from the output port.

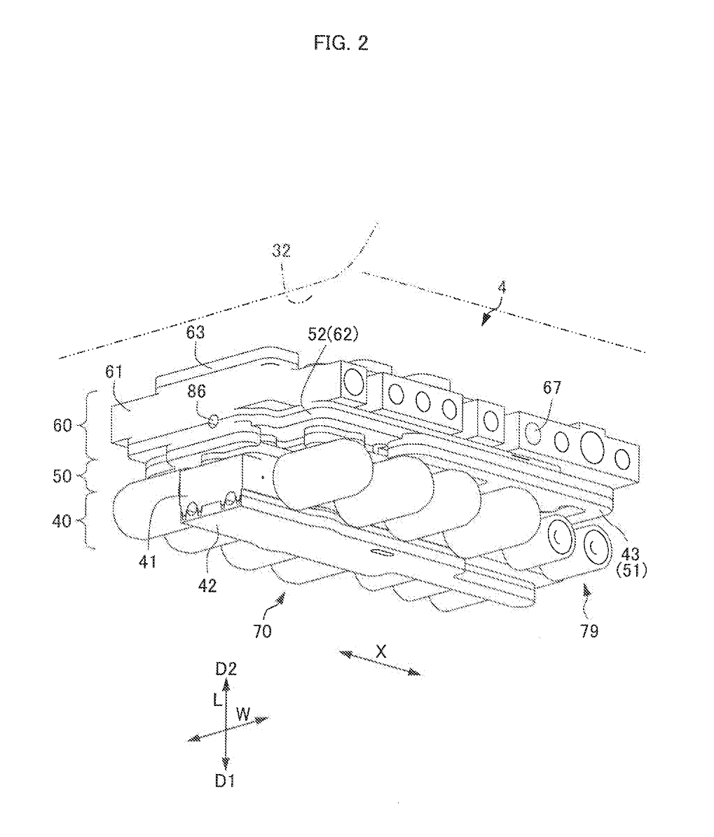

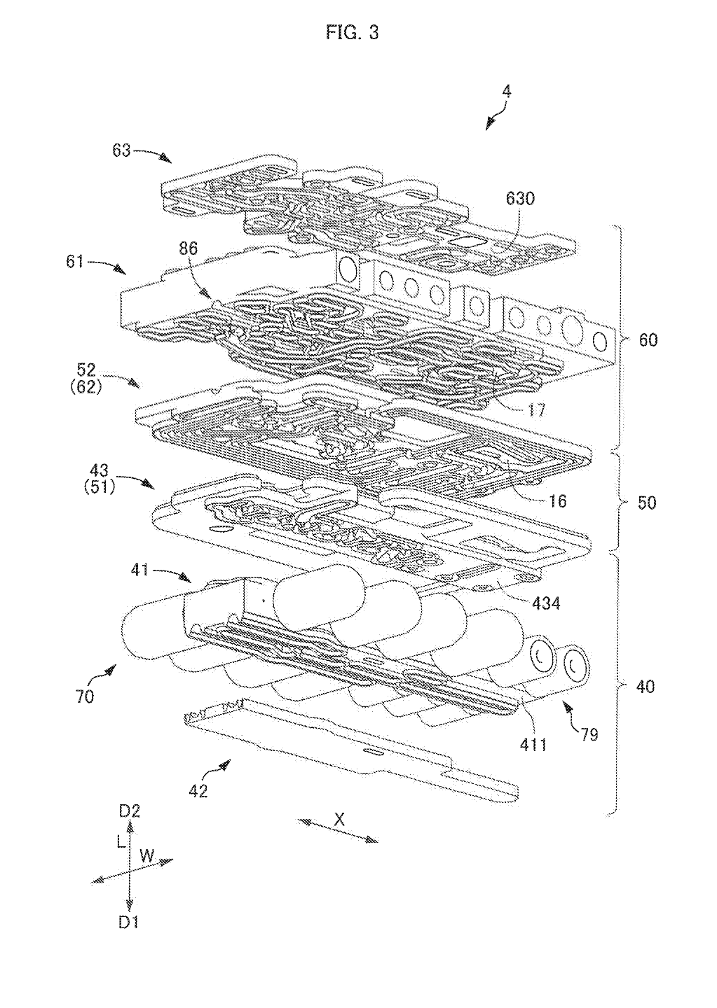

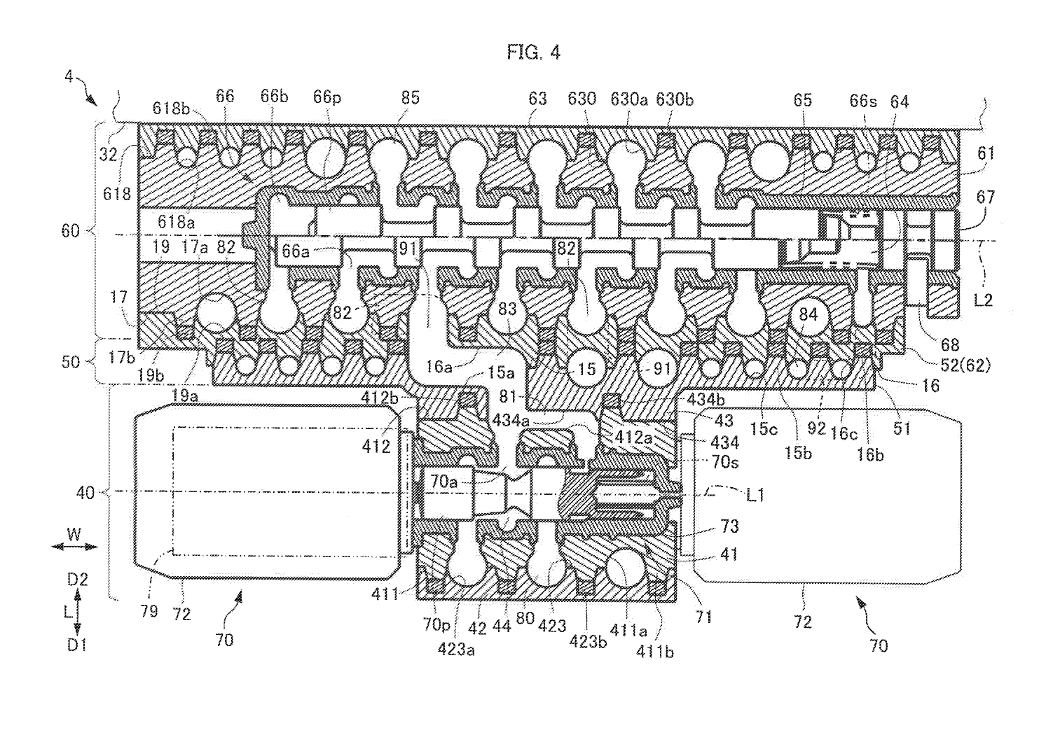

Next, the configuration of the hydraulic control device 4 described above will be described in detail with reference to FIGS. 2 to 5C. As illustrated in FIGS. 2 and 3, the hydraulic control device 4 is a valve body and includes a solenoid installation section 40 accommodating pressure regulating portions 71 of linear solenoid valves 70 and solenoid valves 79, a valve installation section 60 accommodating valves such as switching valves 66 (see FIG. 4), and an oil passage installation section 50 interposed between the solenoid installation section 40 and the valve installation section 60, in a stacked manner.

In the present embodiment, a stacking direction L is defined as a vertical direction, and the valve installation section 60 is attached to the transmission case 32 such that the solenoid installation section 40 is disposed to face downward (first direction D1), and the valve installation section 60 is disposed to face upward (second direction D2). That is, in the stacking direction L, a direction from the oil passage installation section 50 toward the solenoid installation section 40 is defined as the first direction D1, and a direction opposite thereto is defined as the second direction D2. The longitudinal direction of a central axis L1 (see FIG. 4) of each linear solenoid valve 70 described below is defined as a width direction W.

As illustrated in FIGS. 2 to 4, the solenoid installation section 40 includes three layers of substantially plate-shaped synthetic resin blocks, namely, a first block 41, a second block 42, and a third block 43. The solenoid installation section 40 is formed by stacking these three layers and integrating the layers with each other by, for example, injection molding.

The first block 41 is the center layer of the three layers of the solenoid installation section 40, and has a plurality of holes 44 extending inward alternately from an end on one side and another end on the opposite side in the width direction W orthogonal to the stacking direction L. In the present embodiment, the first block 41 is formed by insert-molding bottomed cylindrical metal sleeves 73, in primary injection molding of a DSI method. The inside of each sleeve 73 is the hole 44. The central axis L1 of each sleeve 73 is parallel to the width direction W.

The linear solenoid valves 70 or the solenoid valves 79 are provided in the sleeves 73. The linear solenoid valves 70 and solenoid valves 79 are disposed such that the respective central axes are arranged in parallel on the same plane. Each linear solenoid valve 70 includes a pressure regulating portion 71 that is accommodated in the sleeve 73 and regulates hydraulic pressure by a spool 70p, and a solenoid portion 72 that drives the pressure regulating portion 71 in accordance with an electric signal. The pressure regulating portion 71 includes the spool 70p that is slidably movable to regulate hydraulic pressure, and a biasing spring 70s including a compression coil that pushes the spool 70p in one direction.

Each sleeve 73 has port portions 70a including a large number of through holes, in the peripheral surface thereof. Each port portion 70a has a port formed in the inner peripheral surface of the sleeve 73, a communication hole communicating radially outwardly from the port, and an opening where the communication hole is open in the outer peripheral surface of the sleeve 73. Each port portion 70a is closed at the opening with synthetic resin of the first block 41. The linear solenoid valve 70 described herein can supply hydraulic pressure to, for example, the hydraulic servo 33 capable of engaging and disengaging the first clutch C1. In the present embodiment, the linear solenoid valve 70 has the port portions 70a arranged such that hydraulic pressure is supplied from the second block 42 side and is output from the third block 43 side. However, the embodiment is not limited thereto.

In the present embodiment, the linear solenoid valve 70 generates output pressure, based on input hydraulic pressure, in accordance with an electric signal. The solenoid valve 79 is an on-off solenoid valve that switches between supply and interruption of supply of output pressure in accordance with an electric signal. The linear solenoid valves 70 and the solenoid valves 79 are parallel and adjacent to each other, along a direction crossing (for example, a direction orthogonal to) the stacking direction L.

The first block 41 includes a first face 411 disposed on the first direction D1 side, a plurality of grooves 411a each having a semicircular cross-sectional shape and formed in the first face 411, and projections 411b formed on the first face 411. The plurality of grooves 411a communicate with some of the plurality of port portions 70a of the linear solenoid valves 70 or the solenoid valves 79. The projections 411b project toward the second block 42. The first block 41 further includes a second face 412 disposed on the second direction D2 side, a plurality of grooves 412a each having a semicircular cross-sectional shape and formed in the second face 412, and projections 412b formed on the second face 412. The plurality of grooves 412a communicate with some of the plurality of port portions 70a of the linear solenoid valves 70 or the solenoid valves 79. The projections 412b project toward the third block 43. The first block 41 further includes, between the first face 411 and the second face 412, the plurality of holes 44 formed along the first face 411 and the second face 412 and accommodating the pressure regulating portions 71.

The second block 42 includes a third face 423 disposed to face the first face 411 of the first block 41, a plurality of grooves 423a each having a semicircular cross-sectional shape and formed in the third face 423, and recesses 423b formed in the third face 423. The plurality of grooves 423a are disposed to face the plurality of grooves 411a The third face 423 is stacked to face the first face 411 of the first block 41, so that the plurality of grooves 411a and the plurality of grooves 423a define a plurality of oil passages 80. The recesses 423b are recessed in the same direction as the extending direction of the projections 411b of the first face 411 such that the projections 411b are fitted therein with a clearance in the stacking direction L. The first block 41 and the second block 42 are stacked such that the projections 411b and the recesses 423b fit to each other between the respective adjacent oil passages 80, and are integrated by injection molding in a cavity defined by the clearance between the projections 411b and the recesses 423b.

The third block 43 is stacked on the opposite side of the first block 41 from the second block 42. The third block 43 includes a fourth face 434 facing the second face 412 of the first block 41, a plurality of grooves 434a each having a semicircular cross-sectional shape and formed in the fourth face 434, and recesses 434b formed in the fourth face 434. The plurality of grooves 434a are disposed to face the plurality of grooves 412a The fourth face 434 is stacked to face the second face 412 of the first block 41, so that the plurality of grooves 412a and the plurality of grooves 434a define a plurality of oil passages 81. The recesses 434b are recessed in the same direction as the extending direction of the projections 412b of the second face 412 such that the projections 412b are fitted therein with a clearance in the stacking direction L. The first block 41 and the third block 43 are stacked such that the projections 412b and the recesses 434b fit to each other between the respective adjacent oil passages 81, and are integrated by injection molding in a cavity defined by the clearance between the projections 412b and the recesses 434b.

The oil passages 81 defined by the first block 41 and the third block 43 communicate with the valve installation section 60 via the oil passage installation section 50, or establishes communication between the port portions 70a of the linear solenoid valves 70 and the port portions of the solenoid valves 79. The oil passages 80 defined by the first block 41 and the second block 42 establish communication between the port portions 70a of the linear solenoid valves 70 and the port portions of the solenoid valves 79, and communicate with various original pressure supply portions to supply original pressure of line pressure, modulator pressure, and so on to the linear solenoid valve 70 and the solenoid valves 79.

The oil passage installation section 50 includes two layers of substantially plate-shaped synthetic resin blocks, namely, a fourth block (third layer) 51 and a fifth block (first layer) 52. The oil passage installation section 50 is formed by stacking these two layers and integrating the layers with each other by, for example, injection molding. In the present embodiment, the fourth block 51 is disposed on the second direction D2 side of the third block 43 and the fourth block 51 and the third block 43 are formed of a single member. However, the fourth block 51 and the third block 43 do riot have to be formed of a single member, and may be formed of different members and integrated by injection molding, bonding, welding, or the like.

The fourth block 51 includes a fifth face (fourth surface) 15 disposed on the second direction D2 side, a plurality of large-diameter fourth grooves 15a and a plurality of small-diameter grooves 15c each having a semicircular cross-sectional shape and formed in the fifth face 15, and projections 15b formed on the fifth face 15. The projections 15b project in the second direction D2, and are disposed to surround the plurality of grooves 15a and 15c on the fifth face 15. The plurality of fourth grooves 15a are disposed to overlap the pressure regulating portions 71 of the linear solenoid valves 70 as viewed from the stacking direction L. The plurality of small-diameter grooves 15c are disposed to overlap the solenoid portions 72 of the linear solenoid valves 70 as viewed from the stacking direction L.

The fifth block 52 includes a sixth face (third surface) 16 disposed to face the fifth face 15 of the fourth block 51, a plurality of large-diameter third grooves 16a and a plurality of small-diameter grooves 16c each having a semicircular cross-sectional shape and formed in the sixth face 16, and recesses 16b formed in the sixth face 16. The plurality of third grooves 16a are disposed to face the plurality of fourth grooves 15a. The plurality of small-diameter grooves 16c are disposed to face the plurality of small-diameter grooves 15c. The sixth face 16 is stacked to face the fifth face 15 of the fourth block 51, so that the plurality of third grooves 16a and the plurality of fourth grooves 15a define a plurality of large-diameter third oil passages 83, and the plurality of small-diameter grooves 16c and the plurality of small-diameter grooves 15c define a plurality of small-diameter oil passages 84. The recesses 16b are recessed in the same direction as the extending direction of the projections 15b of the fifth face 15 such that the projections 15b are fitted therein with a clearance in the stacking direction L. That is, the recesses 16b are disposed to surround the plurality of grooves 16a and 16c on the sixth face 16. The fourth block 51 and the fifth block 52 are stacked such that the projections 15b and the recesses 16b fit to each other between the respective adjacent oil passages 83 and 84, and are integrated by injection molding in a cavity defined by the clearance between the projections 15b and the recesses 16b.

The direction crossing the stacking direction L in which the third oil passages 83 and small-diameter oil passages 84 are disposed includes a direction orthogonal to and a direction inclined to the stacking direction L. Each of the oil passages 83 and 84 may have a portion extending in a direction along the stacking direction L. In the present embodiment, the cross-sectional shape of the third oil passages 83 and the small-diameter oil passages 84 is a substantially circular shape, The substantially circular shape includes a continuously curved shape of the cross section of the oil passages 83 and 84, such as the shape of an ellipse, other than the shape of a perfect circle.

The third oil passage 83 communicates with a communication oil passage (first oil passage) 91 formed inside at least one of the fourth block 51 and the fifth block 52. The communication oil passage 91 communicates with the large-diameter oil passage 81 formed between the second face 412 and the fourth face 434, the large-diameter second oil passage 82 formed between a seventh face 17 and a ninth face 19, and so on, for example. The small-diameter oil passage 84 communicates with a small-diameter communication oil passage 92 formed inside at least one of the fourth block 51 and the fifth block 52. The small-diameter communication oil passage 92 has a smaller diameter than the communication oil passage 91, and communicates with a small-diameter oil passage formed between the second face 412 and the fourth face 434, a small-diameter oil passage formed between the seventh face 17 and the ninth face 19, and so on, for example. Accordingly, the oil passages 83 and 84 can circulate hydraulic oil between the fourth block 51 and the fifth block 52, from the fourth block 51 to the fourth block 51, or from the fifth block 52 to the fifth block 52, for example. Further, the oil passages 83 and 84 establish communication between two of the hydraulic servo 33 of the first clutch C1, the port portions 70a of the linear solenoid valves 70, and port portions 66a of the switching valves 66, for example.

In the present embodiment, the height of each projection 15b is less than the depth of each recess 16b. The space between the distal end face of the projection 15b and the bottom hire of the recess 16b is filled with a seal member, and the projection 15b and the recess 16b are joined by the seal member. The seal member is an injection molding material, and the projection 15b and the recess 16b are joined by injection molding.

In the present embodiment, the third oil passages 83 are used for circulating hydraulic oil of a large flow rate, such as line pressure, range pressure, and hydraulic pressure for controlling a frication engagement element, for example. The small-diameter oil passages 84 are used for circulating hydraulic oil of a small flow rate, such as signal pressure for the switching valves 66, for example.

The valve installation section 60 includes three layers of substantially plate-shaped synthetic resin blocks, namely, a sixth block (second layer) 61, a seventh block 62, and an eighth black 63. The valve installation section 60 is formed by stacking these three layers and integrating the layers with each other by, for example, injection molding. The valve installation section 60 is stacked on the opposite side of the oil passage installation section 50 from the solenoid installation section 40 in the stacking direction L, and accommodates the switching valves 66. In the present embodiment, the sixth block 61 is disposed on the second direction D2 side of the seventh block 62, and the sixth black 61 and the seventh block 62 are formed of a single member. However, the sixth block 61 and the seventh block 62 do not have to be formed of a single member, and may be formed of different members and integrated by injection molding, bonding, welding, or the like.

The sixth block 61 is the center layer of the three layers of the valve installation section 60, and has a plurality of holes 64 extending inward from an end on one side and another end on the opposite side in the width direction W orthogonal to the stacking direction L. In the present embodiment, the sixth block 61 is formed by insert-molding bottomed cylindrical metal sleeves 65, in primary injection molding of a DSI method. The inside of each sleeve 65 is the hole 64. The central axis L2 of each sleeve 65 is parallel to the width direction W.

The switching valves 66 serving as spool valves are formed in the respective sleeves 65. Each sleeve 65 accommodates a slidably movable spool 66p, a biasing spring 66s including a compression coil that pushes the spool 66p in one direction, and a stopper 67 that keeps the biasing spring 66s pushing the spool 66p. These elements form the switching valve 66. The stopper 67 is fixed near the opening of the sleeve 65 by a retainer 68. Each sleeve 65 has the port portions 66a including a large number of through holes, in the peripheral surface thereof. Each port portion 66a has a port formed in the inner peripheral surface of the sleeve 65, a communication hole communicating radially outwardly from the port, and an opening where the communication hole is open in the outer peripheral surface of the sleeve 65. Each port portion 66a is closed at the opening with synthetic resin of the sixth block 61. The switching valve 66 can switch an oil passage or regulate the hydraulic pressure, for example. The switching valve 66 capable of switching an oil passage is a spool valve including the movable spool 66p, the biasing spring 66s that biases the spool 66p in one direction, and a hydraulic oil chamber 66b in which the spool 66p is moved in a direction against the biasing spring 66s by the supplied hydraulic pressure.

The sixth block 61 includes the seventh face (second surface) 17, a plurality of second grooves 17a each having a semicircular cross-sectional shape and formed in the seventh face 17, and projections 17b formed on the seventh face 17. The plurality of second grooves 17a communicate with some of the plurality of port portions 66a of the switching valves 66. Each projection 17b is formed between the adjacent second grooves 17a in the seventh face 17, and projects toward the seventh block 62. The sixth block 61 further includes an eighth face 618 disposed on the side opposite to the seventh face 17, a plurality of grooves 618a each having a semicircular cross-sectional shape and formed in the eighth face 618, and projections 618b formed on the eighth face 618. The plurality of grooves 618a communicate with some of the plurality of port portions 66a of the switching valves 66. Each projection 618b is formed between the adjacent grooves 618a in the eighth face 618, and projects toward the eighth block 63. The sixth block 61 further includes, between the seventh face 17 and the eighth face 618, a plurality of holes 64 formed along the seventh face 17 and the eighth face 618 and accommodating the switching valves 66.

The seventh block 62 is stacked on the opposite side of the sixth block 61 from the transmission case 32. In the present embodiment, the seventh block 62 is disposed on the second direction D2 side of the fifth block 52, and the seventh block 62 and the fifth block 52 are formed of a single member. However, the seventh block 62 and the fifth block 52 do not have to be formed of a single member, and may be formed of different members and integrated by injection molding, bonding, welding, or the like.

The seventh block 62 includes the ninth face (first surface) 19, a plurality of first grooves 19a each having a semicircular cross-sectional shape and formed in the ninth face 19, and recesses 19b formed in the ninth face 19. The plurality of first grooves 19a are disposed to face the plurality of second grooves 17a The ninth face 19 is stacked to face the seventh face 17 of the sixth block 61 in the stacking direction L, so that the plurality of second grooves 17a and the plurality of first grooves 19a define a plurality of second oil passages 82. The oil passages 83 and 84 and the second oil passage 82 communicate with each other in a direction crossing (for example, orthogonal to) the opposing faces of the seventh face 17, the ninth face 19, and so on.

The recesses 19b are recessed in the same direction as the extending direction of the projections 17b of the seventh face 17 such that the projections 17b are fitted therein with a clearance in the stacking direction L. In the present embodiment, the sixth block 61 and the seventh block 62 are stacked such that the projections 17b and the recesses 19b fit to each other between the respective adjacent second oil passages 82, and are integrated by injecting an injection molding material into the clearance between the projections 17b and the recesses 19b and thereby performing injection molding in a cavity defined by the clearance.

The eighth block 63 is stacked on the opposite side of the sixth block 61 from to the seventh block 62, and is attached to the transmission case 32. The eighth block 63 includes a tenth face 630, a plurality of grooves 630a each having a semicircular cross-sectional shape and formed in the tenth face 630, and recesses 630b formed in the tenth face 630. The plurality of grooves 630a are disposed to face the plurality of grooves 618a. The tenth face 630 is stacked to face the eighth face 618 of the sixth block 61, so that the plurality of grooves 630a and the plurality of grooves 618a define a plurality of oil passages 85.

The recesses 630b are recessed in the same direction as the extending direction of the projections 618b of the eighth face 618 such that the projections 618b are fitted therein with a clearance in the stacking direction L. The sixth block 61 and the eighth block 63 are stacked such that the projections 618b and the recesses 630b fit to each other between the respective adjacent oil passages 85, and are integrated by injection molding in a cavity defined by the clearance between the projections 618b and the recesses 630b.

In the present embodiment, a drain oil passage 86 (see FIGS. 2 and 3) is provided, for example, between the sixth block 61 and the seventh block 62. The drain oil passage 86 is formed in both the seventh face 17 and the ninth face 19 by the second grooves 17a formed in the seventh face 17 and the first grooves 19a formed in the ninth face 19, and communicates with the outside of the sixth block 61 and the seventh block 62 to drain hydraulic oil. There is no joining portion around the drain oil passage 86.

Of the oil passages 82 and 85 communicating with the switching valves 66 in the valve installation section 60, the large-diameter oil passages for circulating hydraulic oil of a large flow rate communicate directly with other switching valves 66 in the valve installation section 60, communicate with other switching valves 66 in the valve installation section 60 via the third oil passages 83 in the oil passage installation section 50, or communicate with the linear solenoid valves 70 or the solenoid valves 79 in the solenoid installation section 40 via the third oil passages 83 in the oil passage installation section 50, for example. Of the oil passages 82 and 85 communicating with the switching valves 66 in the valve installation section 60, the small-diameter oil passages for circulating hydraulic oil of a small flow rate communicate directly with other switching valves 66 in the valve installation section 60, communicate with other switching valves 66 in the valve installation section 60 via the small-diameter oil passages 84 in the oil passage installation section 50, or communicate with the solenoid valves 79 in the solenoid installation section 40 via the small-diameter oil passages 84 in the oil passage installation section 50, for example. That is, at least some of the oil passages 83 and 84 in the oil passage installation section 50 establish communication between the linear solenoid valves 70 in the solenoid installation section 40 and the switching valves 66 in the valve installation section 60.

In the above description, the projections 15b formed on the fifth face 15 and the recesses 16b formed in the sixth face 16 are joined to surround and seal the oil passages 83 and 84 located in both the fifth face 15 and the sixth face 16. This configuration is not limited to the projections 15b and the recesses 16b. That is, the projections and recesses in the other faces are disposed to surround the respective adjacent oil passages, so that the projections and recesses are joined to seal the oil passages. In the present embodiment, the projections 411b and the recesses 423b are joined to surround and seal the oil passages 80; the projections 412b and the recesses 434b are joined to surround and seal the oil passages 81; the projections 17b and the recesses 19b are joined to surround and seal the second oil passages 82; and the projections 618b and the recesses 630b are joined to surround and seal the oil passages 85.

The valve body of the hydraulic control device 4 for the automatic transmission 3 described above is manufactured with a DSI method. Therefore, when the valve body of the hydraulic control device 4 is manufactured, each of the first block 41 to the eighth block 63 is fowled by injection molding, and the opposing die is relatively moved without removing each of the first block 41 to the eighth block 63 from the mold. By die sliding, layers are stacked by fitting the projections to the recesses, and the stacked layers are integrated by injection-molding synthetic resin into the cavity. The die sliding and stacking process is performed on each of the interfaces of the first block 41 to the eighth block 63, so that a valve body is formed. In the present embodiment, a seal member that integrates the stacked blocks is an injection molding material. However, the embodiment is not limited thereto. For example, adhesive may be used. That is, the projections and recesses of the layers may be integrated by bonding. In this case, the valve body can be assembled at low cost.

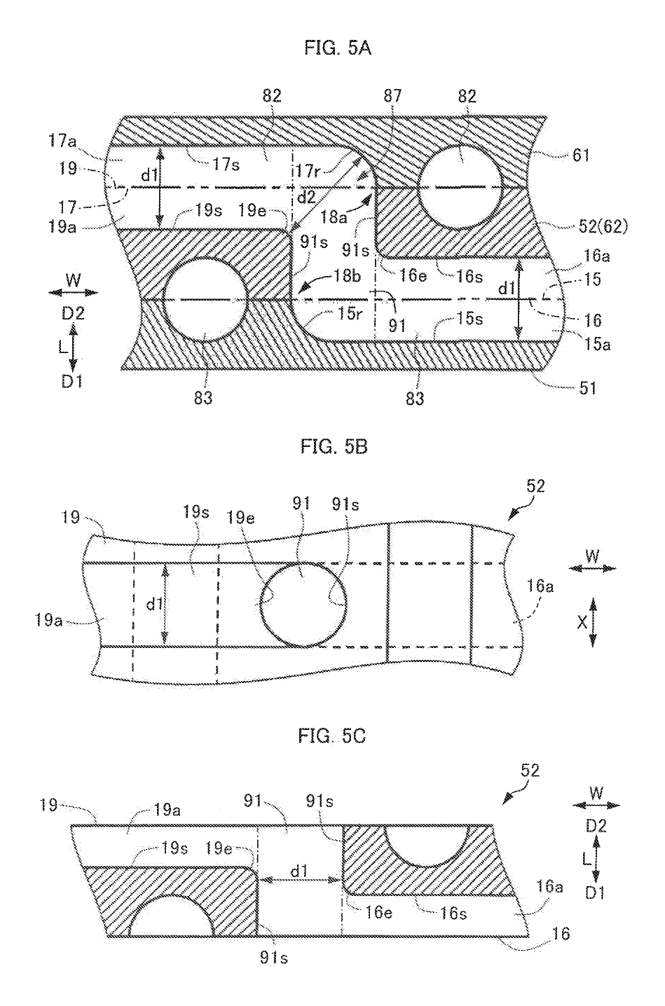

Next, the oil passages formed in the valve body of the hydraulic control device 4 for the automatic transmission 3 described above will be described in detail with reference to FIG. 4 and FIGS. 5A to 5C. The following describes an exemplary oil passage formed between the sixth block 61 and the fourth block 51, with the fifth block 52 interposed therebetween.

As illustrated in FIGS. 5A to 5C, the fifth block 52 includes the ninth face 19 on the second direction D2 side, the first groove 19a having a semicircular cross-sectional shape and formed in the ninth face 19, and the communication oil passage 91 having a circular cross-sectional shape, communicating with an end 19e of the first groove 19a, extending in the direction (stacking direction L) orthogonal to the ninth face 19, and open to the first groove 19a. In the present embodiment, the communication oil passage 91 has a cross-sectional shape of a perfect circle, and extends through the fifth block 52 in the stacking direction L, with a constant diameter d1. The sixth block 61 includes the seventh face 17, and second grooves 17a each having a semicircular cross-sectional shape and formed in the seventh face 17 to face the first groove 19a. The sixth block 61 is stacked on the fifth block 52, with the seventh face 17 joined to the ninth face 19. The second oil passage 82 has a circular cross-sectional shape, is defined by the first groove 19a of the ninth face 19 and the second groove 17a of the seventh face 17, and communicates with the communication oil passage 91. In the example illustrated in FIG. 5A, the second oil passage 82 is disposed to have the central axis extending in the width direction W. In the present embodiment, the communication oil passage 91 extends through the fifth block 52 in the stacking direction L. However, the embodiment is not limited thereto. For example, the communication oil passage 91 may be configured to establish communication between a port portion of a sleeve that is formed in the fifth block 52 by insert molding and the first groove 19a, without extending through the fifth block 52, for example.

The second groove 17a includes a straight portion 17s and a curved portion (end) 17r, as viewed from an orthogonal direction X (see FIG. 5B) orthogonal to the stacking direction L and the width direction W. The straight portion 17s is formed to face the end 19e of the first groove 19a, and linearly extends along the seventh face 17. In the present embodiment, the straight portion 17s extends beyond the end 19e of the first groove 19a to the central axis of the communication oil passage 91. The curved portion 17r is formed in a curved shape extending from the straight portion 17s to the seventh face 17. In the present embodiment, the curved portion 17r has an arcuate shape having the same radius as the communication oil passage 91. That is, the curved portion 17r of the second groove 17a at the end of the second oil passage 82 communicating with the communication oil passage 91 is formed to have a depth gradually decreasing toward the end of the second oil passage 82, and is continuously connected to the communication oil passage 91 in the fifth block 52. In the present embodiment, the curved portion 17r of the second groove 17a at the end of the second oil passage 82 has an arcuate cross-sectional shape continuous with the communication oil passage 91, and has a concave spherical shape.

The end 19e of the first groove 19a at the end of the second oil passage 82 has an arcuate cross-sectional shape having a depth gradually increasing toward the end of the second oil passage 82, and is continuously connected to the communication oil passage 91. The curvature radius of the end 19e of the first groove 19a is less than the curvature radius of the curved portion 17r of the second groove 17a The first groove 19a includes a linear straight portion 19s facing the straight portion 17s of the second groove 17a and extending along the ninth face 19, as viewed from the orthogonal direction X. The communication oil passage 91 includes a linear straight portion (wall portion) 91s extending to the ninth face 19, as viewed from the orthogonal direction X. The first groove 19a and the communication oil passage 91 are joined to the second groove 17a without a level difference. That is, for example, the distal end portion of the curved portion 17r of the second groove 17a on the seventh face 17 and the opposing portion of the straight portion 91s of the communication oil passage 91 on the ninth face 19 are joined to each other at a joining portion 18a without a level difference.

In the present embodiment, a wall portion defining the communication oil passage 91 in the fifth block 52 is the straight portion 91s extending orthogonally to the ninth face 19. That is, the communication oil passage 91 has a shape not having an undercut portion extending into the inside of the communication oil passage 91, in the extending direction (stacking direction L). Therefore, when the fifth block 52 is formed by injection molding, mold can be removed. In the present embodiment, the communication oil passage 91 has a cylindrical inner peripheral surface extending in the stacking direction L, and does not have an undercut portion. However, the shape of the communication oil passage 91 is not limited thereto. For example, even in the case where the communication oil passage 91 has a conical inner peripheral surface with a greater diameter at the center and a smaller diameter at the outer end in the stacking direction L, the communication oil passage 91 does not have an undercut portion. Note that in FIG. 5A, the oil passage 82 at the upper right and the oil passage 83 at the lower left are other oil passages that are orthogonal to the second oil passage 82 and the third oil passage 83.

The fifth block 52 includes the sixth face 16 that is disposed on the first direction Di side opposite to the ninth face 19 and in which the communication oil passage 91 is open, and the third groove 16a having a semicircular cross-sectional shape, formed in the sixth face 16, and having an end 16e communicating with the communication oil passage 91. The fourth block 51 includes the fifth face 15, and the fourth groove 15a having a semicircular cross-sectional shape and formed in the fifth face 15 to face the third groove 16a The fourth block 51 is stacked on the opposite side of the fifth block 52 from the sixth block 61, with the fifth face 15 joined to the sixth face 16. The third oil passage 83 has a circular cross-sectional shape, is defined by the third groove 16a of the sixth face 16 and the fourth groove 15a of the fifth face 15, and communicates with the communication oil passage 91. In the example illustrated in FIG. 5A, the third oil passage 83 is disposed to have the central axis extending in the width direction W and to be parallel to the second oil passage 82. However, the third oil passage 83 may be disposed to face another direction so as to include the fifth face 15 and the sixth face 16.

The fourth groove 15a includes a straight portion 15s and a curved portion (end) 15r, as viewed from the orthogonal direction X. The straight portion 15s is formed to face the end 16e of the third groove 16a, and linearly extends along the fifth face 15. In the present embodiment, the straight portion 15s extends beyond the end 16e of the third groove 16a to the central axis of the communication oil passage 91. The curved portion 15r is formed in a curved shape extending from the straight portion 15s to the fifth face 15. In the present embodiment, the curved portion 15r has an arcuate shape having the same radius as the communication oil passage 91. That is, the curved portion 15r of the fourth groove 15a at the end of the third oil passage 83 communicating with the communication oil passage 91 is formed to have a depth gradually decreasing toward the end of the third oil passage 83, and is continuously connected to the communication oil passage 91 in the fifth block 52. In the present embodiment, the curved portion 15r of the fourth groove 15a at the end of the third oil passage 83 has an arcuate cross-sectional shape continuous with the communication oil passage 91, and has a concave spherical shape.

The end 16e of the third groove 16a at the end of the third oil passage 83 has an arcuate cross-sectional shape having a depth gradually increasing toward the end of the third oil passage 83, and is continuously connected to the communication oil passage 91. The curvature radius of the end 16e of the third groove 16a is less than the curvature radius of the curved portion 15r of the fourth groove 15a, The third groove 16a includes a linear straight portion 16s facing the straight portion 15s of the fourth groove 15a and extending along the sixth face 16, as viewed from the orthogonal direction X. The communication oil passage 91 includes the linear straight portion 91s extending to the sixth face 16, as viewed from the orthogonal direction X. The third groove 16a and the communication oil passage 91 are joined to the fourth groove 15a without a level difference. That is, for example, the distal end portion of the curved portion 15r of the fourth groove 15a on the fifth face 15 and the opposing portion of the straight portion 91s of the communication oil passage 91 on the sixth face 16 are joined to each other at a joining portion 18b without a level difference.

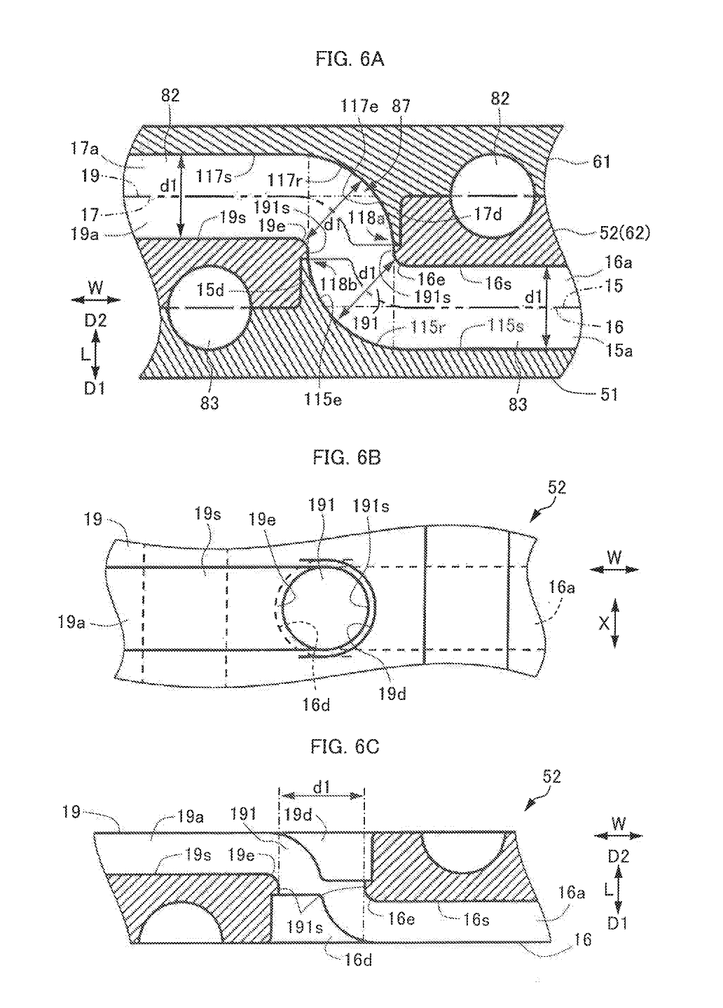

In the present embodiment, the second oil passage 82, the communication oil passage 91, and the third oil passage 83 have a shape of a perfect circle with the same diameter d1 in their cross sections orthogonal to the respective central axes, and have the same cross-sectional area (see FIG. 6A to 6C). Accordingly, compared to the case where the oil passages 82, 83, and 91 have different cross-sectional areas, pressure loss of hydraulic oil can be reduced. Further, there is no level difference at the joining portion 18a between the second oil passage 82 and the communication oil passage 91 and at the joining portion 18b between the third oil passage 83 and the communication oil passage 91. Accordingly, compared to the case where there is a level difference, pressure loss of hydraulic oil can be reduced.

In the present embodiment illustrated in FIGS. 5A to 5C, the second groove 17a has a constant width, with the diameter d1, from the second oil passage 82 to the diameter portion of the communication oil passage 91, and has the same width as the communication oil passage 91 and a communication portion 87 of the second oil passage 82. Note that in the communication portion 87, although the diameter in the orthogonal direction X is the diameter d1 (see FIG. 5B), a major diameter d2 between the end 19e of the first groove 19a and the curved portion 17r of the second groove 17a is greater than the diameter d1. Further, in the present embodiment, the communication oil passage 91 includes the straight portion 91s in the fifth block 52, the curved portion 17r in the sixth block 61, and the curved portion 15r in the fourth block 51, as viewed from the orthogonal direction X orthogonal to the central axes of the communication oil passage 91 and the second oil passage 82.

In FIGS. 5A to 5C, the communication oil passage 91 defined by the fifth block 52, the second oil passage 82 defined by the fifth block 52 and the sixth block 61, and the third oil passage 83 defined by the fifth block 52 and the fourth block 51 are illustrated as an example. The same configuration can be applied to other oil passages in other blocks.

Next, the operation of the hydraulic control device 4 for the automatic transmission 3 described above will be described in detail with reference to FIGS. 1 to 5C.

When the internal combustion engine 2 starts, the oil pump is driven to supply hydraulic pressure. Thus, the regulator valve and the modulator valve generate line pressure and modulator pressure. The generated line pressure and modulator pressure are supplied from the oil passages 81 of the solenoid installation section 40 to the linear solenoid valves 70 and the solenoid valves 79, via the third oil passages 83 or the small-diameter oil passages 84 of the oil passage installation section 50 and the second oil passages 82 of the valve installation section 60. The linear solenoid valves 70 operate in accordance with an electric signal from the ECU 5, and generate and output desired hydraulic pressure, based on the line pressure and modulator pressure. The solenoid valves 79 operate in accordance with an electric signal from the ECU 5, and turn on and off the supply of hydraulic pressure, based on the line pressure and modulator pressure.

Part of the hydraulic pressure supplied from the linear solenoid valves 70 and the solenoid valves 79 flows through the oil passage installation section 50 and the valve installation section 60, and is supplied to the automatic transmission 3. Other part of the hydraulic pressure supplied from the linear solenoid valves 70 and the solenoid valves 79 flows through the oil passage installation section 50, and is supplied to the switching valves 66. Thus, the position of the spool 66p in each switching valve 66 is changed, or communication between the port portions 66a is established or blocked, and the hydraulic pressure is supplied to the automatic transmission 3. When the hydraulic pressure is supplied to the automatic transmission 3, the friction engagement elements of the automatic transmission 3 such as the first clutch C1 and the brake are engaged or disengaged to establish a desired shift speed, or the components of the automatic transmission 3 are lubricated.

As described above, according to the hydraulic control device 4 for the automatic transmission 3 of the present embodiment, the curved portion 17r of the second groove 17a at the end of the second oil passage 82 is formed to have a depth gradually decreasing toward the end of the second oil passage 82, and continues to the communication oil passage 91 in the fifth block 52. Similarly, the curved portion 15r of the fourth groove 15a at the end of the third oil passage 83 is formed to have a depth gradually decreasing toward the end of the third oil passage 83, and continues to the communication oil passage 91 in the fifth block 52. Accordingly, compared to the case where the bottom face and the end face of the second groove 17a are arranged, for example, substantially at right angle, it is possible to prevent the cross-sectional area of the oil passage from varying greatly along the flow path. Therefore, pressure loss of hydraulic oil can be reduced in the communication portion 87 where oil passages formed at different interfaces between stacked layers communicate with each other in the stacking direction L.

Further, according to the hydraulic control device 4 for the automatic transmission 3 of the present embodiment, there is no need to provide a curved portion that curves radially inwardly in the communication oil passage 91 formed in the fifth block 52, and therefore no undercut portion is formed. Accordingly, the fifth block 52 can be more easily formed by injection molding.

Further, according to the hydraulic control device 4 for the automatic transmission 3 of the present embodiment, there is no level difference at the joining portion 18a between the second oil passage 82 and the communication oil passage 91 or at the joining portion 18b between the third oil passage 83 and the communication oil passage 91. Accordingly, compared to the case where there is a level difference, pressure loss of hydraulic oil can be reduced.

According to the hydraulic control device 4 for the automatic transmission. 3 of the present embodiment, both the second oil passage 82 and the third oil passage 83 have a cross-sectional shape of a perfect circle. Therefore, even when the valve body is made of synthetic resin having a lower rigidity than metal, the oil passages 82 and 83 have sufficient pressure resistance in terms of structure. In the case where oil passages have a rectangular cross-sectional shape, stress is concentrated at the rounded corners. In the case of forming such oil passages in a synthetic resin valve body with a low rigidity, the size of the valve body needs to be increased in consideration of stress concentration. Accordingly, it is preferable that the each oil passage have a circular cross-sectional shape, as in the present embodiment.

Further, according to the hydraulic control device 4 for the automatic transmission 3 of the present embodiment, no projection is formed on either the seventh face 17 or the fifth face 15, and therefore the size in the width direction W can be reduced. Accordingly, it is preferable that the present embodiment be applied to an area where oil passages are densely arranged.

In the hydraulic control device 4 for the automatic transmission 3 of the present embodiment, all the layers of the first block 41 to the eighth block 63 are made of synthetic resin. However, the embodiment is not limited thereto. For example, at least one of the layers may be made of metal by aluminum die casting or the like.

In the hydraulic control device 4 for the automatic transmission 3 of the present embodiment, projections and recesses are provided around the grooves at the interface between the blocks, and the projections and recesses are fitted and joined to each other by a seal member. However, the embodiment is not limited thereto. For example, the flat surfaces of the blocks may be joined to each other by injection molding, bonding, welding, or the like, without providing projections and recesses around the grooves at the interface between the blocks.

### Second Embodiment

Next, a second embodiment will be described with reference to FIGS. 6A, 6B, and 6C. The present embodiment is different in configuration from the first embodiment in that, in the hydraulic control device 4 of the present embodiment, the sixth block 61 includes a projection 17d projecting toward the fifth block 52, and the fifth block 52 includes a recess 19d in which the projection 17d is fitted. Further, the present embodiment is different in configuration from the first embodiment in that the fourth block 51 includes a projection 15d projecting toward the fifth block 52 and that the fifth block 52 includes a recess 16d in which the projection 15d is fitted. The configuration of the second embodiment is the same as that of the first embodiment except for these points. Accordingly, elements that are the same as those in the first embodiment are denoted by the same reference numerals, and will not be described in detail herein.

In the present embodiment, the sixth block 61 includes the projection 17d projecting from the seventh face 17 toward the fifth block 52, that is, in the first direction D1, at the end of the second groove 17a The fifth block 52 includes the recess 19d that is recessed in the ninth face 19 and to which the projection 17d is fitted and joined. The projection 17d has an extended portion 117e formed by extending a curved portion (end) 117r of the second groove 17a, and has a concave spherical shape with a constant radius, extending from the bottom face of the second groove 17a to the distal end of the extended portion 117e. In the present embodiment, the extended portion 117e has a curved shape extending to the extended line of the straight portion 19s of the first groove 19a, as viewed from the orthogonal direction X.

The curved portion 117r and the extended portion 117e are formed such that the diameter di from the end 19e of the first groove 19a is equal to the diameter d1 of the second oil passage 82. That is, the curved portion 117r and the extended portion 117e are formed in an arcuate shape about the end 19e of the first groove 19a, with a radius equal to the diameter d1 of the second oil passage 82. Thus, the curved portion 117r and the extended portion 117e are formed to have a curved shape such that the cross-sectional area orthogonal to the central axis of the oil passage defined by the curved portion 117r and the extended portion 117e and by the end 19e of the first groove 19a is equal to the cross-sectional area of the second oil passage 82. Note that as in the first embodiment, a communication oil passage 191 has a cross-sectional shape of a perfect circle, and extends through the fifth block 52 in the stacking direction L, with the diameter d1. The distal end of the extended portion 117e and a straight portion 191s of the communication oil passage 191 are joined to each other at a joining portion 118a without a level difference.

The fourth block 51 includes the projection 15d projecting from the fifth face 15 toward the fifth block 52, that is, in the second direction D2, at the end of the fourth groove 15a The fifth block 52 includes the recess 16d that is recessed in the sixth face 16 and to which the projection 15d is fitted and joined. The projection 15d has an extended portion 115e formed by extending a curved portion (end) 115r of the fourth groove 15a. In the present embodiment, the extended portion 115e has a curved shape extending to the extended line of the straight portion 16s of the third groove 16a, as viewed from the orthogonal direction X.

The curved portion 115r and the extended portion 115e are aimed such that a diameter of the third groove 16a from the end 16e is equal to the diameter d1 of the third oil passage 83. That is, the curved portion 115r and the extended portion 115e are formed in an arcuate shape about the end 16e of the third groove 16a, with a radius equal to the diameter d1 of the third oil passage 83. Thus, the curved portion 115r and the extended portion 115e are formed to have a curved shape such that the cross-sectional. area orthogonal to the central axis of the oil passage defined by the curved portion 115r and the extended portion 115e and by the end 16e of the third groove 16a is equal to the cross-sectional area of the third oil passage 83. The distal end of the extended portion 115e and the straight portion 191s of the communication oil passage 191 are joined to each other at a joining portion 118b without a level difference.

Accordingly, the cross-sectional area orthogonal to the flow path is constant throughout the second oil passage 82, the communication oil passage 91, and the third oil passage 83, including the bent communication portions. Therefore, pressure loss of hydraulic oil can be greatly reduced.

According to the hydraulic control device 4 for the automatic transmission 3 of the present embodiment, the curved portion 117r and the extended portion 117e of the second groove 17a at the end of the second oil passage 82 are formed to have a depth gradually decreasing toward the end of the second oil passage 82, and continue to the communication oil passage 91 in the fifth block 52. Further, the curved portion 115r and the extended portion 115e of the fourth groove 15a at the end of the third oil passage 83 are formed to have a depth gradually decreasing toward the end of the third oil passage 83, and continue to the communication oil passage 91 in the fifth block 52. Accordingly, compared to the case where the bottom face and the end face of the second groove 17a are arranged, for example, substantially at right angle, it is possible to prevent the cross-sectional area of the oil passage from varying greatly along the flow path. Therefore, pressure loss of hydraulic oil can be reduced in the communication portion 87 where oil passages formed at different interfaces between stacked layers communicate with each other in the stacking direction L.

In the hydraulic control device 4 for the automatic transmission 3 of the present embodiment, the cross-sectional area orthogonal to the flow path is constant throughout the second oil passage 82, the communication oil passage 91, and the third oil passage 83, including the bent communication portions. Therefore, pressure loss of circulating hydraulic oil can be greatly reduced. That is, the second oil passage 82, the communication oil passage 91, and the third oil passage 83 have a constant cross-sectional shape and a constant cross-sectional area, and therefore have a great effect in reducing pressure loss. Accordingly, the hydraulic control device 4 of the present embodiment is preferably applied to a flow path with a large flow rate and a relatively low pressure, such as a lubricating flow path and a cooler flow path in the valve body of the automatic transmission 3.

In the hydraulic control device 4 for the automatic transmission 3 of the present embodiment, the extended portions 117e and 115e have a curved shape as viewed from the orthogonal direction X. However, the embodiment is not limited thereto. For example, the extended portions 117e and 115e may be partly straight.

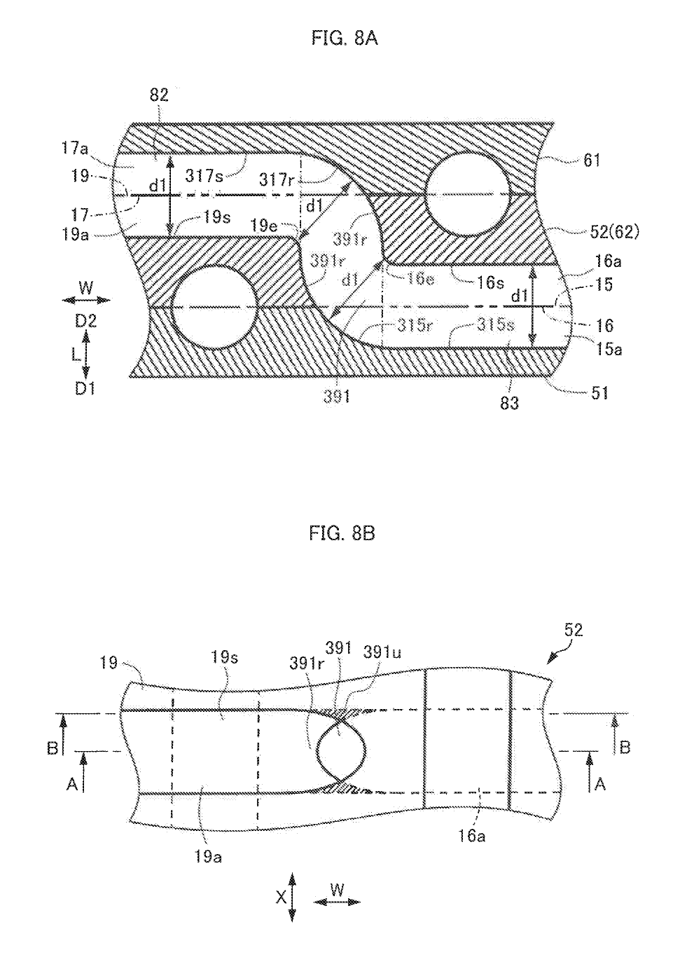

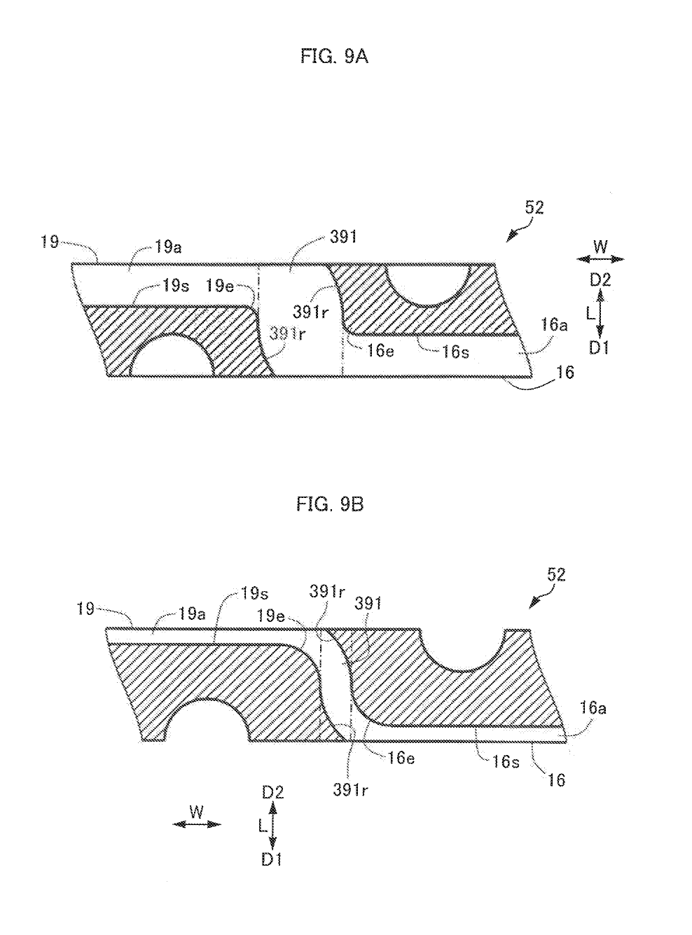

Now, a configuration in which the second oil passage 82, the communication oil passage 91, and the third oil passage 83 have the same cross-sectional area while the projections 17d and 15d and the recesses 19d and 16d of the present embodiment are not provided will be described in detail with reference to FIGS. 8A to 9B.

As illustrated in FIG. 8A, a communication oil passage 391 includes a curved portion 391r extending from the ninth face 19 to the extended line of the straight portion 19s of the first groove 19a, as viewed from the orthogonal direction X. A curved portion 317r of the second groove 17a and the curved portion 391r are continuous with each other without a level difference, and are formed in an arcuate shape about the end 19e of the first groove 19a, with a radius equal to the diameter of the second oil passage 82. Thus, the cross-sectional area orthogonal to the central axis of the oil passage defined by the curved portion 317r and the curved portion 391r and by the end 19e of the first groove 19a is equal to the cross-sectional area of the second oil passage 82. Further, the communication oil passage 391 includes the curved portion 391r extending from the sixth face 16 to the extended line of the straight portion 16s of the third groove 16a, as viewed from the orthogonal direction X. A curved portion 315r of the fourth groove 15a and the curved portion 391r are continuous with each other without a level difference, and are formed in an arcuate shape about the end 16e of the third groove 16a, with a radius equal to the diameter of the third oil passage 83. Thus, the cross-sectional area orthogonal to the central axis of the oil passage defined by the curved portion 315r and the curved portion 391r and by the end 16e of the third groove 16a is equal to the cross-sectional area of the third oil passage 83. Accordingly, the cross-sectional area orthogonal to the flow path is constant throughout the second oil passage 82, the communication oil passage 91, and the third oil passage 83, including the bent communication portions.

However, as illustrated in FIGS. 8B, 9A, and 9B, the fifth block 52 including the communication oil passage 391 with a constant cross-sectional area has an undercut portion 391u at the side of the communication oil passage 391, as viewed from the stacking direction L. Therefore, with the injection molding method that moves the mold in the stacking direction L, it may not be possible to create the fifth block 52.

Meanwhile, in the present embodiment, as illustrated in FIGS. 6A to 6C, the projections 17d and 15d and the recesses 19d and 16d are formed at the portion corresponding to the undercut portion 391u of FIG. 8B so as not to have the undercut portion 391u. Accordingly, it is possible to form the second oil passage 82, the communication oil passage 91, and the third oil passage 83 such that the cross-sectional area orthogonal to the flow path is constant, without having an undercut portion.

### Third Embodiment

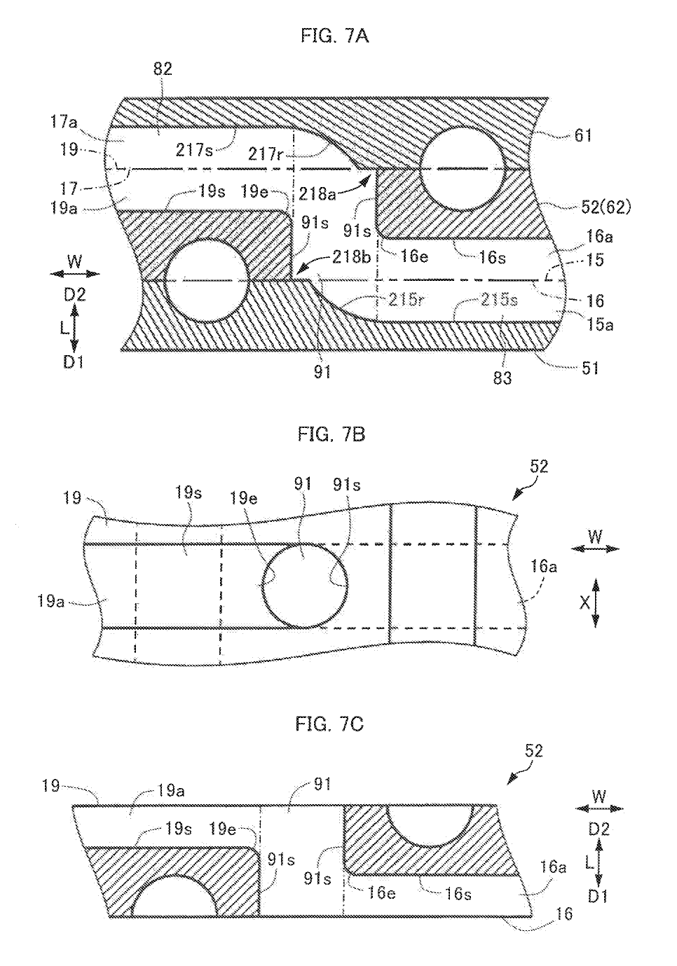

Next, a third embodiment will be described in detail with reference to FIGS. 7A, 7B, and 7C. A hydraulic control device 4 of the present embodiment is different in configuration from that of the first embodiment in that a curved portion 217r of the second groove 17a extends from the position facing the end 19e of the first groove 19a, and its diameter from the end 19e of the first groove 19a is equal to the diameter of the second oil passage 82. The hydraulic control device 4 of the present embodiment is also different in configuration from that of the first embodiment in that a curved portion 215r of the fourth groove 15a extends from the position facing the end 16e of the third groove 16a, and its diameter from the end 16e of the third groove 16a, is equal to the diameter of the third oil passage 83. The configuration of the third embodiment is the same as that of the first embodiment except for these points. Accordingly, elements that are the same as those in the first embodiment are denoted by the same reference numerals, and will not be described in detail herein. Moreover, the configuration of the fifth block 52 is the same as that of the first embodiment.

In the present embodiment, a straight portion 217s of the second groove 17a extends to the end 19e of the first groove 19a, and the curved portion 217r of the second groove 17a is formed in a curved shape extending from the straight portion 217s to the seventh face 17. Further, the curved portion 217r of the second groove 17a is formed to have a curved shape such that the cross-sectional area orthogonal to the central axis of the oil passage defined by the curved portion 217r and the end 19e of the first groove 19a is equal to the cross-sectional area of the second oil passage 82. That is, the curved portion 217r of the second groove 17a is formed in an arcuate shape about the end 19e of the first groove 19a, with a radius equal to the diameter of the second oil passage 82. Note that as in the first embodiment, the communication oil passage 91 has a cross-sectional shape of a perfect circle, and extends through the fifth block 52 in the stacking direction L, with a constant diameter. Therefore, for example, there is a level difference at a joining portion 218a between the distal end portion of the curved portion 217r of the second groove 17a on the seventh face 17 and the opposing portion of the straight portion 91s of the communication oil passage 91 on the ninth face 19.

In the present embodiment, a straight portion 215s of the fourth groove 15a extends to the end 16e of the third groove 16a, and the curved portion 215r of the fourth groove 15a is formed in a curved shape extending from the straight portion 215s to the fifth face 15. Further, the curved portion 215r of the fourth groove 15a is formed to have a curved shape such that the cross-sectional area orthogonal to the central axis of the oil passage defined by the curved portion 215r and the end 16e of the third groove 16a is equal to the cross-sectional area of the third oil passage 83. That is, the curved portion 215r of the fourth groove 15a is formed in an arcuate shape about the end 16e of the third groove 16a, with a radius equal to the diameter of the third oil passage 83. Therefore, for example, there is a level difference at a joining portion 218b between the distal end portion of the curved portion 215r of the fourth groove 15a on the fifth face 15 and the opposing portion of the straight portion 91s of the communication oil passage 91 on the sixth face 16.

According to the hydraulic control device 4 of the automatic transmission 3 of the present embodiment, the second groove 17a forming the second oil passage 82 includes the linear straight portion 217s extending along the seventh face 17, and the curved portion 217r with a curved shape extending from the straight portion 217s to the seventh face 17, as viewed from the orthogonal direction X. The fourth groove 15a forming the third oil passage 83 includes the linear straight portion 215s extending along the fifth face 15, and the curved portion 215r with a curved shape extending from the straight portion 21.5s to the fifth face 15, as viewed from the orthogonal direction X. Accordingly, compared to the case where the bottom thee and the end face of each of the second groove 17a and the fourth groove 15a are arranged substantially at right angle, it is possible to prevent the cross-sectional area of the oil passage from varying greatly along the flow path. Further, there is no need to provide a curved portion that curves radially inwardly in the communication oil passage 91 formed in the fifth block 52, and therefore no undercut portion is formed. Accordingly, pressure loss of hydraulic pressure can be reduced at portions where the communication oil passage 91 is bent to communicate with the second oil passage 82 and the third oil passage 83, without having an undercut portion.

In the hydraulic control device 4 for the automatic transmission 3 of the present embodiment, the curved portion 217r of the second groove 17a is formed to have a curved shape such that the cross-sectional area orthogonal to the central axis of the oil passage defined by the curved portion 217r and the end 19e of the first groove 19a is equal to the cross-sectional area of the second oil passage 82. Accordingly, the second oil passage 82 has a constant cross-sectional area along the flow path at the region Where the curved portion 217r of the second groove 17a is disposed. Therefore, pressure loss of hydraulic oil can be reduced. Similarly, the curved portion 215r of the fourth groove 15a is formed to have a curved shape such that the cross-sectional area orthogonal to the central axis of the oil passage defined by the curved portion 215r and the end 16e of the third groove 16a is equal to the cross-sectional area of the third oil passage 83. Accordingly, the third oil passage 83 has a constant cross-sectional area along the flow path at the region where the curved portion 215r of the fourth groove 15a is disposed. Therefore, pressure loss of hydraulic oil can be reduced.

The embodiments include at least the following configuration. A hydraulic control device (4) for a vehicle transmission apparatus (3) of the present embodiment includes: a first layer (52) including a first surface (19), a first groove (19a) having a semicircular cross-sectional shape and formed in the first surface (19), and a first oil passage (91, 191) having a circular cross-sectional shape, communicating with an end (19e) of the first groove (19a), extending in a direction orthogonal to the first surface (19), and open to the first groove (19a); a second layer (61) including a second surface (17), and a second groove (17a) having a semicircular cross-sectional shape and formed in the second surface (17) to face the first groove (19a), and the second layer (61) is stacked on the first layer (52), with the second surface (17) joined to the first surface (1.9); and a second oil passage (82) having a circular cross-sectional shape, defined by the first groove (19a) in the first surface (19) and the second groove (17a) in the second surface (17), and communicating with the first oil passage (91, 191). In the hydraulic control device (4), the second groove (17a) at an end of the second oil passage (82) communicating with the first oil passage (91, 191) is formed to have a depth gradually decreasing toward the end of the second oil passage (82), and is continuously connected to the first oil passage (91, 191) in the first layer (52). According to this configuration, the second groove (17a) at the end of the second oil passage (82) is formed to have a depth gradually decreasing toward the end of the second oil passage (82), and is continuously connected to the first oil passage (91, 191) in the first layer (52). Accordingly, compared to the case where the bottom face and the end face of the second groove (17a) are arranged, for example, substantially at right angle, it is possible to prevent the cross-sectional area of the oil passage from varying greatly along the flow path. Therefore, pressure loss of hydraulic oil can be reduced at the portion where oil passages formed at different interfaces between stacked layers communicate with each other in the stacking direction.

In the hydraulic control device (4) for the vehicle transmission apparatus (3) of the embodiments, the second groove (17a) at the end of the second oil passage (82) has an arcuate cross-sectional shape continuous with the first oil passage (91, 191); the first groove (19a) at the end of the second oil passage (82) has an arcuate cross-sectional shape having a depth gradually increasing toward the end of the second oil passage (82), and is continuously connected to the first oil passage (91, 191); and a curvature radius of the end (19e) of the first groove (19a) is less than a curvature radius of an end (17r) of the second groove (17a), According to this configuration, it is possible to prevent the cross-sectional area of the oil passage from varying greatly along the flow path, and therefore pressure loss of hydraulic oil can be reduced.

In the hydraulic control device (4) for the vehicle transmission apparatus (3) of the embodiments, a wall portion (91s, 191s) defining the first oil passage (91, 191) in the first layer (52) extends orthogonally from the first surface (19), According to this configuration, the first oil passage (91, 191) is formed in a shape not having an undercut portion in the extending direction, and therefore the first layer (52) can be formed by injection molding or the like using molds for molding the first layer (52) therebetween in the stacking direction (L).

In the hydraulic control device (4) for the vehicle transmission apparatus (3) of the embodiments, a cross-sectional area of the second oil passage (82) in a plane orthogonal to the second oil passage (82) is equal to a cross-sectional area of the first oil passage (91, 191) in a plane orthogonal to the first oil passage (91, 191). According to this configuration, the first oil passage (91, 191) and the second oil passage (82) have a constant cross-sectional area along the flow path, and therefore pressure loss of hydraulic oil can be reduced.

In the hydraulic control device (4) for the vehicle transmission apparatus (3) of the embodiments, a cross-sectional shape of the second oil passage (82) in a plane orthogonal to the second oil passage (82) is identical to a cross-sectional shape of the first oil passage (91, 191) in a plane orthogonal to the first oil passage (91, 191). According to this configuration, the first oil passage (91, 191) and the second oil passage (82) have a constant cross-sectional area and shape along the flow path, and therefore pressure loss of hydraulic oil can be more effectively reduced.

In the hydraulic control device (4) for the vehicle transmission apparatus (3) of the embodiments, a width of the second groove (17a) is equal to a diameter (d1) of the first oil passage (91, 191), and is equal to a width of a communication portion (87) where the first oil passage (91, 191) and the second oil passage (82) communicate orthogonally with each other. According to this configuration, in the first oil passage (91, 191) and the second oil passage (82), pressure loss of hydraulic oil can be reduced.

In the hydraulic control device (4) for the vehicle transmission apparatus (3) of the embodiments, the first layer (52) and the second layer (61) are made of synthetic resin; and an end (17r) of the second groove (17a) has a concave spherical shape. According to this configuration, compared to a valve body made of metal, it is possible to obtain a lightweight and inexpensive valve body with high productivity.

In the hydraulic control device (4) for the vehicle transmission apparatus (3) of the embodiment, the second layer (61) includes a projection (17d) projecting from the second surface (17) toward the first layer (52), at the end of the second groove (17a); the first layer (52) includes a recess (19d) that is recessed in the first surface and to which the projection (17d) is fitted and joined; and the projection (17d) has an extended portion (117e) formed by extending the second groove (17a), and has a concave spherical shape with a constant radius, extending from a bottom face of the second groove (17a) to a distal end of the extended portion (117e). According to this configuration, the extended portion (117e) defines an oil passage that is equivalent to the first oil passage (191) having an inwardly curved inner peripheral surface, Further, since the extended portion (117e) is formed in the second layer (61), an inwardly curved shape of the inner peripheral surface of the first oil passage (191) is not formed in the first layer (52). Therefore, it is possible to prevent an undercut portion from being formed in the first layer (52) in the stacking direction (L). Accordingly, it is possible to form an inwardly curved shape of the inner peripheral surface of the first oil passage (191) while preventing an undercut portion from being formed in the first layer (52) in the stacking direction (L). Thus, it is possible to prevent the cross-sectional area at a joining portion (118a) between the second oil passage (82) and the first oil passage (191) from varying greatly along the flow path, and therefore pressure loss of hydraulic oil can be reduced.

In the hydraulic control device (4) for the vehicle transmission apparatus (3) of the embodiments, the first oil passage (91, 191) includes a straight portion (91s, 191s) in the first layer (52), and a curved portion (17r, 117r) in the second layer (61), as viewed from an orthogonal direction that is orthogonal to central axes of the first oil passage (91, 191) and the second oil passage (82). According to this configuration, the first oil passage (91, 191) can be formed in a shape not having an undercut portion in the extending direction of the first oil passage (91, 191), and therefore the first layer (52) can be formed by injection molding or the like using molds for molding the first layer (52) therebetween in the stacking direction (L).

The hydraulic control device (4) for the vehicle transmission apparatus (3) of the embodiments further includes: a third layer (51) stacked on an opposite side of the first layer (52) from the second layer (61). In the hydraulic control device (4), the first layer (52) includes a third surface (16) that is disposed on a side opposite to the first surface (19) and in which the first oil passage (91, 191) is open, and a third groove (16a) having a semicircular cross-sectional shape, formed in the third surface (16), and having an end communicating with the first oil passage (91, 191); the third layer (51) includes a fourth surface (15), and a fourth groove (15a) having a semicircular cross-sectional Shape and formed in the fourth surface (15) to face the third groove (16a), and the third layer (51) is stacked on the first layer (52), with the fourth surface (15) joined to the third surface (16); a third oil passage (83) having a circular cross-sectional shape and communicating with the first oil passage (91, 191) is defined by the third groove (16a) in the third surface (16) and the fourth groove (15a) in the fourth surface (15); and the fourth groove (15a) at an end of the third oil passage (83) communicating with the first oil passage (91, 191) is formed to have a depth gradually decreasing toward the end of the third oil passage (83), and is continuously connected to the first oil passage (91, 191) in the first layer (52). According to this configuration, even in the case of a three-layered valve body, pressure loss of hydraulic oil can be reduced at the portions where oil passages formed at different interfaces between different stacked layers are bent in a direction orthogonal to the interfaces.

### INDUSTRIAL APPLICABILITY

A hydraulic control device for a vehicle transmission apparatus according to the present disclosure can be mounted on, for example, a vehicle or the like, and is particularly suitably used for an automatic transmission that switches engagement elements and the like by supplying and exhausting hydraulic pressure.

1. A hydraulic control device for a vehicle transmission apparatus, the hydraulic control device comprising:
a first layer including a first surface, a first groove having a semicircular cross-sectional shape and formed in the first surface, and a first oil passage having a circular cross-sectional shape, communicating with an end of the first groove, extending in a direction orthogonal to the first surface, and open to the first groove;
a second layer including a second surface, and a second groove having a semicircular cross-sectional shape and formed in the second surface to face the first groove, the second layer being stacked on the first layer, with the second surface joined to the first surface; and
a second oil passage having a circular cross-sectional shape, defined by the first groove in the first surface and the second groove in the second surface, and communicating with the first oil passage,
wherein the second groove at an end of the second oil passage communicating with the first oil passage is formed to have a depth gradually decreasing toward the end of the second oil passage, and is continuously connected to the first oil passage in the first layer.

2. The hydraulic control device for a vehicle transmission apparatus according to claim 1,
wherein the second groove at the end of the second oil passage has an arcuate cross-sectional shape continuous with the first oil passage;
wherein the first groove at the end of the second oil passage has an arcuate cross-sectional shape having a depth gradually increasing toward the end of the second oil passage, and is continuously connected to the first oil passage; and
wherein a curvature radius of the end of the first groove is less than a curvature radius of an end of the second groove.

3. The hydraulic control device for a vehicle transmission apparatus according to claim 2, wherein a wall portion defining the first oil passage in the first layer extends orthogonally from the first surface.

4. The hydraulic control device for a vehicle transmission apparatus according to claim 3, wherein a cross-sectional area of the second oil passage in a plane orthogonal to the second oil passage is equal to a cross-sectional area of the first oil passage in a plane orthogonal to the first oil passage.

5. The hydraulic control device for a vehicle transmission apparatus according to claim 4, wherein a cross-sectional shape of the second oil passage in a plane orthogonal to the second oil passage is identical to a cross-sectional shape of the first oil passage in a plane orthogonal to the first oil passage.

6. The hydraulic control device for a vehicle transmission apparatus according to claim 5, wherein a width of the second groove is equal to a diameter of the first oil passage, and is equal to a width of a communication portion where the first oil passage and the second oil passage communicate orthogonally with each other.

7. The hydraulic control device for a vehicle transmission apparatus according to claim 6,
wherein the first layer and the second layer are made of synthetic resin; and
wherein an end of the second groove has a concave spherical shape.

8. The hydraulic control device for a vehicle transmission apparatus according to claim 7,
wherein the second layer includes a projection projecting from the second surface toward the first layer, at the end of the second groove;
wherein the first layer includes a recess that is recessed in the first surface and to which the projection is fitted and joined; and
wherein the projection has an extended portion formed by extending the second groove, and has a concave spherical shape with a constant radius, extending from a bottom face of the second groove to a distal end of the extended portion.

9. The hydraulic control device for a vehicle transmission apparatus according to claim 8, wherein the first oil passage includes a straight portion in the first layer, and a curved portion in the second layer, as viewed from an orthogonal direction that is orthogonal to central axes of the first oil passage and the second oil passage.

10. The hydraulic control device for a vehicle transmission apparatus according to claim 9, the hydraulic control device further comprising:
a third layer stacked on an opposite side of the first layer from the second layer;
wherein the first layer includes a third surface that is disposed on a side opposite to the first surface and in which the first oil passage is open, and a third groove having a semicircular cross-sectional shape, formed in the third surface, and having an end communicating with the first oil passage;
wherein the third layer includes a fourth surface, and a fourth groove having a semicircular cross-sectional shape and formed in the fourth surface to face the third groove, the third layer being stacked on the first layer, with the fourth surface joined to the third surface;
wherein a third oil passage having a circular cross-sectional shape and communicating with the first oil passage is defined by the third groove in the third surface and the fourth groove in the fourth surface; and
wherein the fourth groove at an end of the third oil passage communicating with the first oil passage is formed to have a depth gradually decreasing toward the end of the third oil passage, and is continuously connected to the first oil passage in the first layer.

11. The hydraulic control device for a vehicle transmission apparatus according to claim 1, wherein a wall portion defining the first oil passage in the first layer extends orthogonally from the first surface.

12. The hydraulic control device for a vehicle transmission apparatus according to claim 11, wherein a cross-sectional area of the second oil passage in a plane orthogonal to the second oil passage is equal to a cross-sectional area of the first oil passage in a plane orthogonal to the first oil passage.

13. The hydraulic control device for a vehicle transmission apparatus according to claim 11, wherein a cross-sectional shape of the second oil passage in a plane orthogonal to the second oil passage is identical to a cross-sectional shape of the first oil passage in a plane orthogonal to the first oil passage.

14. The hydraulic control device for a vehicle transmission apparatus according to claim 1, wherein a cross-sectional area of the second oil passage in a plane orthogonal to the second oil passage is equal to a cross-sectional area of the first oil passage in a plane orthogonal to the first oil passage.

15. The hydraulic control device for a vehicle transmission apparatus according to claim 14, wherein a cross-sectional shape of the second oil passage in a plane orthogonal to the second oil passage is identical to a cross-sectional shape of the first oil passage in a plane orthogonal to the first oil passage.

16. The hydraulic control device for a vehicle transmission apparatus according to claim 1, wherein a cross-sectional shape of the second oil passage in a plane orthogonal to the second oil passage is identical to a cross-sectional shape of the first oil passage in a plane orthogonal to the first oil passage.

17. The hydraulic control device for a vehicle transmission apparatus according to claim 1, wherein a width of the second groove is equal to a diameter of the first oil passage, and is equal to a width of a communication portion where the first oil passage and the second oil passage communicate orthogonally with each other.

18. The hydraulic control device for a vehicle transmission apparatus according to claim 1,
wherein the first layer and the second layer are made of synthetic resin; and
wherein an end of the second groove has a concave spherical shape.

19. The hydraulic control device for a vehicle transmission apparatus according to claim 1, wherein the first oil passage includes a straight portion in the first layer, and a curved portion in the second layer, as viewed from an orthogonal direction that is orthogonal to central axes of the first oil passage and the second oil passage.

20. The hydraulic control device for a vehicle transmission apparatus according to claim 1, the hydraulic control device further comprising:
a third layer stacked on an opposite side of the first layer from the second layer;
wherein the first layer includes a third surface that is disposed on a side opposite to the first surface and in which the first oil passage is open, and a third groove having a semicircular cross-sectional shape, formed in the third surface, and having an end communicating with the first oil passage;
wherein the third layer includes a fourth surface, and a fourth groove having a semicircular cross-sectional shape and formed in the fourth surface to face the third groove, the third layer being stacked on the first layer, with the fourth surface joined to the third surface;
wherein a third oil passage having a circular cross-sectional shape and communicating with the first oil passage is defined by the third groove in the third surface and the fourth groove in the fourth surface; and
wherein the fourth groove at an end of the third oil passage communicating with the first oil passage is formed to have a depth gradually decreasing toward the end of the third oil passage, and is continuously connected to the first oil passage in the first layer.
